(19) United States
(12) Patent Application Publication
(10) Pub. No.: US 2005/0082245 A1
(43) Pub. Date: Apr. 21, 2005

(54) Rod with angled slots for drying clothes in bathtub

(76) Inventor: Ray Arjomand, New York, NY (US)

Correspondence Address: Ray Arjomand, #3E, 570 Isham Street, New York, NY, 10034, US

(21) Appl. No.: 10/961,884

(22) Filed: Oct. 9, 2004

Related U.S. Application Data
(60) Provisional application No. 60/511,766, filed on Oct. 16, 2003.

(51) Int. Cl. B42F 13/12

(52) U.S. Cl. 211/125; 211/119.011; 211/100

(57) ABSTRACT

A rod structure for hanging wet clothes adapted to fit in a bathtub. The rod structure may be either a single slanted piece or a vertical piece connected to a slanted piece. The slanted piece contains a longitudinal axis and contains either slots or bulges along the slanted piece, which slots or bulges which are parallel to each other. The slots or bulges are positioned in such a way that they are not perpendicular to the longitudinal axis.

### CROSS REFERENCE TO RELATED APPLICATIONS

This application corresponds in subject matter to Disclosure Document No. 527437, entitled “BATHTUB CLOTHES DRYER WITH ANGLED GROOVES”, dated Mar. 11, 2003 and relies on the filing date of Oct. 16, 2003 for Provisional Application Ser. No. 60/511,766.

### BACKGROUND OF THE INVENTION

1) Field of the Invention

This invention relates generally to the field of drying clothes in a bathtub and more specifically to drying clothes in a bathtub without wetting the bathroom floor. Using an electric (rotating) dryer can be expensive and time consuming. Besides, clothes dried in the electric dryers form a large mass, mixing with one another and leaving wrinkles. Hanging wet clothes from a shower-curtain rod has several disadvantages including, the water drips from the wet clothes to the bathroom floor outside of the bathtub, soaking the bathroom floor and the weight of wet clothes may break or loosen the shower curtain rod.

Despite these disadvantages, people hang their wet clothes from their shower curtain rods anyway. There is a need to provide a quick, easy, and economical means for drying clothes in a bathtub without any of the above disadvantages.

2) Description of the Related Art

There are several prior art US Patents that use rods to dry clothes in bathtub. Examples can be seen in U.S. Pat. No. 5,499,725, entitled “Removable Bath Accessory Bar”; U.S. Pat. No. 5,394,621, entitled “Garment Dryer”; U.S. Pat. No. 4,103,781, entitled “Portable Adjustable Clothes Drying Device”; U.S. Pat. No. 4,846,356, entitled “Rigid Clothes Drying Rack”; and U.S. Pat. No. 3,471,031, entitled “Clothes Drying Rack”. However, none uses a rod that is parallel to the shower-curtain rod, nor do they have angled slots on the rod for preventing water leakage outside the bathtub. U.S. Pat. No. 5,647,492, entitled “Movement Resistant Angled Clothes Hanger Rod Structure” describes a space-saving clothes hanger rod structure for holding (dry) clothes hangers in an optimal angled position within a closet having a minimal depth therein. It provides for a V shaped rod, holding the clothes hanger hooks in two spaced-apart points.

### BRIEF SUMMARY OF THE INVENTION

The object of the present invention is to provide a quick, easy economical means for drying clothes in a bathtub without wetting the bathroom floor. Another object is to provide a quick, easy economical means for drying clothes in a bathtub without wrinkles.

Other objects and advantages will become apparent from the following descriptions, taken in connection with the accompanying drawings, wherein, by way of illustration and example, an embodiment is disclosed.

In accordance with this invention, there is disclosed one or more rods (rod structure) used for drying clothes in a bathtub. The rod(s) has parallel angled slots or bulges (not perpendicular to the longitudinal axis of the rod) on its surface. The clothes hanger hooks are placed in the parallel slots (or are supported by the bulges) on the rod. The suspended wet clothes hang at an angle because the slots/bulges are at an angle. Since the wet clothes hang at an angle, the wet clothes will not drip outside of the bathtub onto the bathroom floor even though the wet clothes are wider than the width of the bathtub.

The drawings constitute a part of this specification and include exemplary embodiments, which may be embodied in various forms. It is to be understood that in some instances various aspects may be shown exaggerated or enlarged to facilitate an understanding of the invention.

### BRIEF DESCRIPTION OF THE DRAWINGS

FIG. 1 is a perspective view of the rod structure of the present invention in a bathtub.

FIG. 2 is a close-up top plan view of the rod portion with the slots thereon.

FIG. 3 is a perspective view of clothes hanging from a rod showing the approximate dimensions.

FIG. 4A is a top plan view of clothes hanging from the rod at an angle inside a bathtub.

FIG. 4B is similar to 4A with the clothes hanging from the rod at a sharper angle.

FIG. 5 is an embodiment of the rod that is mounted in the bathtub at an angle.

FIG. 6 is a top plan view for FIGS. 7 and 8 and is similar to FIG. 2.

FIG. 7 is a side view of wet clothes hanging on a rod with angled slots.

FIG. 8 is a side view of wet clothes hanging on a rod with angled bulges.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

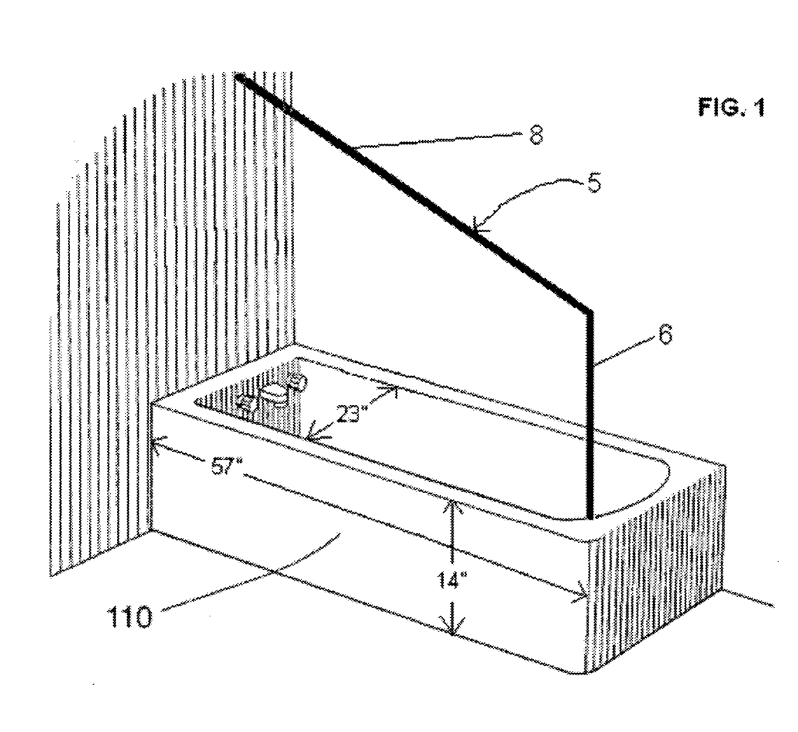

FIG. 1 is a perspective view of the rod structure 5 of the present invention in a bathtub 110. The measurements are shown in inches. The outside length of the tub 110 is approximately 57″. The inside length of the tub 110 is approximately 47″. The inside width of the bathtub 110 (as shown) is approximately 23″. Most bathtubs are approximately this size. However, if the bathtub is a different shape or size the present invention will still function.

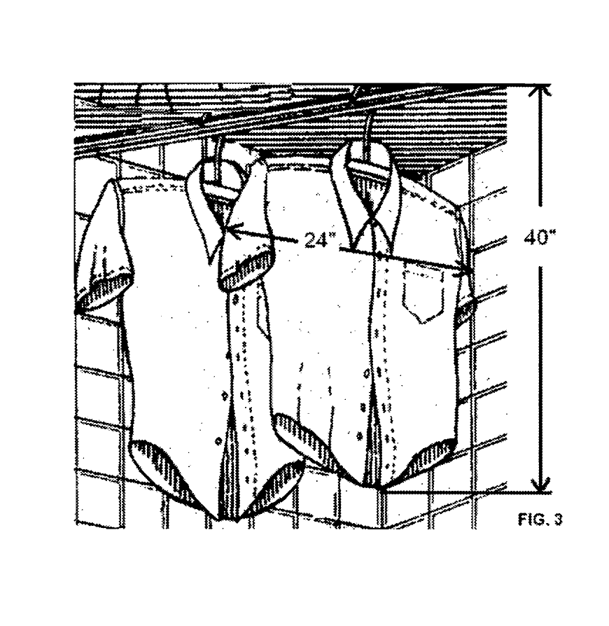

The rod structure 5 is placed inside the bathtub 110 as shown. The rod structure 5 is composed of two rods (6 and 8). Alternatively, it may consist of one rod, bent at the junction between 6 and 8. Rod 6 is the vertical support leg for rod 8 and is preferably more than 40″ tall. 40″ is the approximate length of typical hung clothes (see FIG. 3). One end of rod 8 is supported by vertical rod 6, and the other end leans against the bathroom wall as shown. Rod 8 is at least 62″ tall but can be longer if needed. The excess length can get cut off by the customer depending on the size of his bathtub. In other embodiments (not shown) rod structure 5 may have a curve or zigzag to allow for more surface area on the rod to hang wet clothes on. The vertical portion 6 may have a base (not shown) to stand on. The base may be plastic and filled with water for added weight. Ideally the rod structure would be easy to assemble/disassemble and remove for storage when the clothes have been dried.

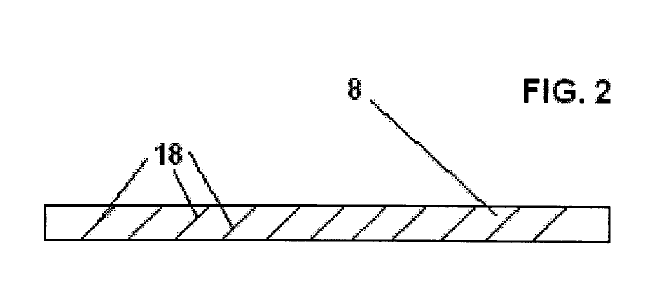

FIG. 2 is a plan top view of rod 8 having parallel slots 18 on its surface. Instead of slots, the rod 8 may have bulges 19 on it with the same purpose. Wet clothes 89 are hung with a hanger 84 on rod 8. The hanger hooks are placed into the slots 18. Since the wet clothes 89 are hung from the hangers 84 inserted into the slots 18, the clothes 89 will not slide off the rod 8 even if it is at an angle other than horizontal. The slots 18 are approximately 6″ apart to allow for sufficient air circulation between wet clothes. Since the rod 8 is approximately 62″ long and the slots are approximately 6″ apart, there will be room for approximately 10 slots. This allows for 10 pieces of wet clothes 89 to be hung on the rod 8 at one time.

FIG. 3 is a drawing of typical clothes 89 hung from a rod to dry. The width of the clothes 89 hanging from the hanger 84 is approximately 24″ which is 1″ longer than the width of the bathtub 110 (23″ as shown in FIG. 1). For this reason if the slots 18 on rod 8 were not at an angle, the wet clothes 89 would drip outside of the bathtub 110.

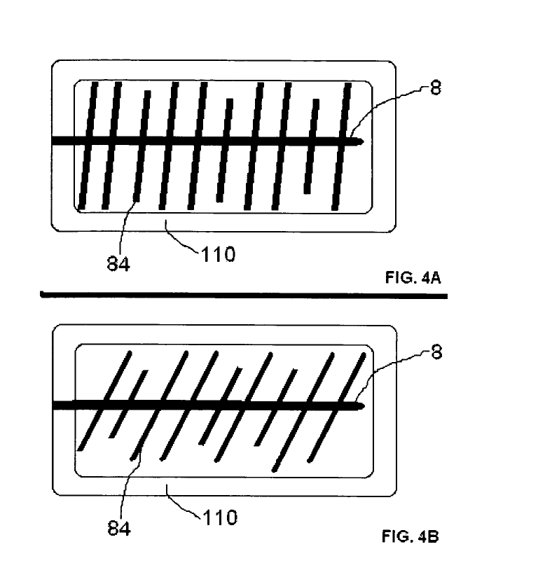

FIGS. 4A and 4B provide a top plan view of bathtub 110. As shown, rod 8 has wet clothes 89 hung on it. The clothes 89 are attached to hangers which are inserted into the slots 18 on the rod 8 so that they don't slide. Since the parallel slots 18 are at an angle, the wet clothes 89 hang at an angle (as shown). This prevents water from leaking outside the bathtub 110. The difference between FIGS. 4A and 4B lies in the angle of the slots on the rod 8. FIG. 4B has a sharper angle than 4A.

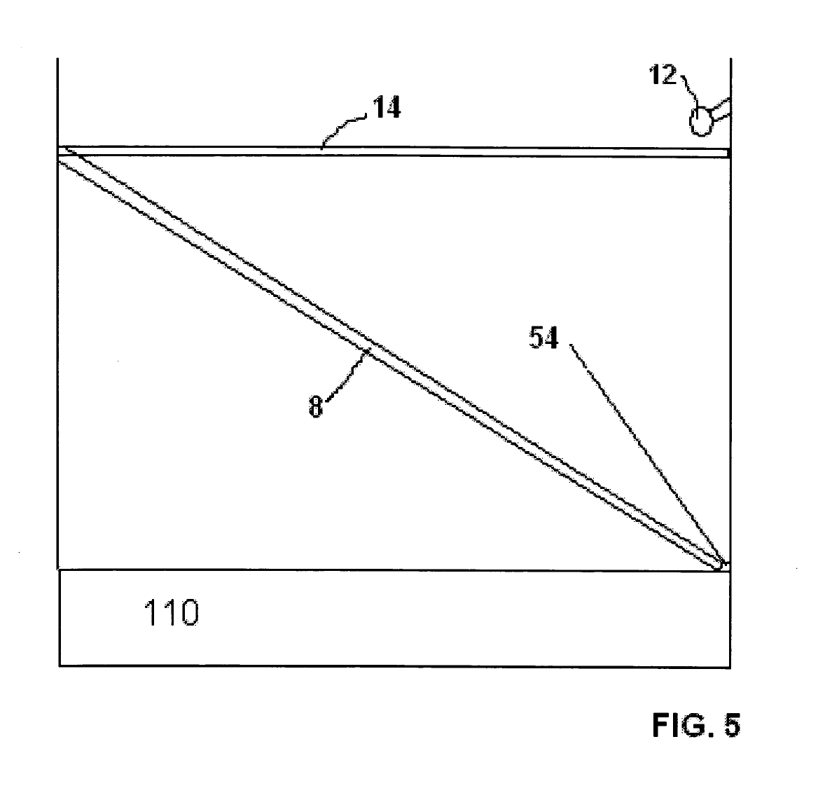

FIG. 5 is a simplified embodiment comprised of only one rod 8 that is approximately 7′ long. As shown, one end of the rod is placed at the corner 54 where the bathtub 110 and the bathroom walls meet, and the other end leans against the point at which the bathroom wall and shower curtain 14 meet. Once again, Rod 8 has angled slots 18 as shown in FIG. 2.

Since rod 8 is approximately 7′ tall, and the slots are approximately 6″ apart, there will be room for approximately 14 pieces of clothing on the rod 8. However, at the lower end of the rod 8, only short clothes such as socks and shorts may be hung. Since the length of a hung shirt is approximately 40″ (see FIG. 3), it will drag on the bathtub floor if it is hung at the lower end of rod 8.

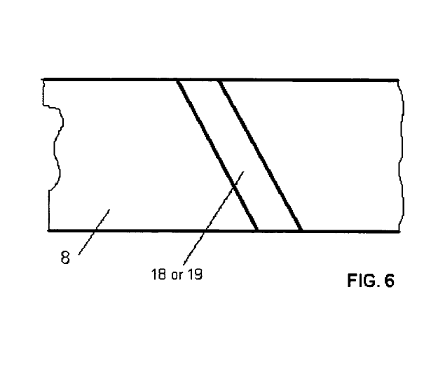

FIG. 6 is the top view of rod 8 and it shows one of the parallel slots 18 at an angle non-perpendicular to the longitudinal axis of the rod 8.

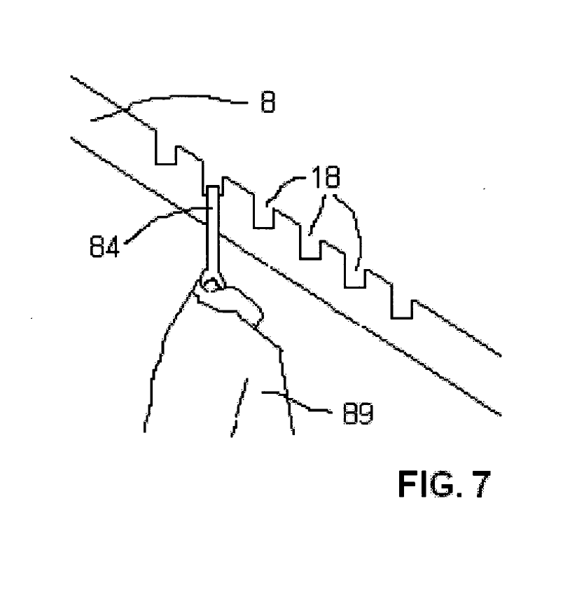

FIG. 7 is a side view drawing enlarged to see the details more clearly. The rod 8 has slots 18 on its surface. Wet clothes 89 are attached to the hanger 84 which is placed inside one of the slots 18.

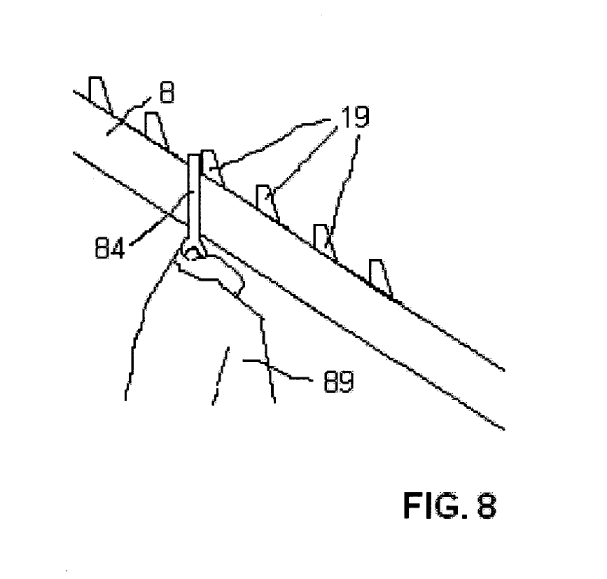

FIG. 8 is similar to FIG. 7 except that the rod has bulges 19 instead of slots 18. Wet clothes 89 are attached to the hanger 84 which is supported by the bulge 19 on the surface of rod 8.

While the invention has been described in connection with a preferred embodiment, it is not intended to limit its scope to the particular form set forth, but on the contrary, it is intended to cover such alternatives, modifications, and equivalents as may be included within its spirit and scope.

1. A rod structure for hanging wet clothes in a bathtub which comprises, a rod having a first end, a second end, and a longitudinal axis, which rod contains slots or bulges which are parallel to each other but are not perpendicular to the longitudinal axis of the rod.

2. The rod structure of claim 1, wherein the rod structure comprises a single slanted rod which will fit in the bathtub with the first end of the rod higher than a second end of the rod.

3. The rod structure of claim 2, wherein the rods or bulges are positioned so that clothes hangers positioned in the slots or held by the bulges will be vertical when the rod is positioned in the bathtub and clothes hangers positioned in the slots or held by the bulges will be diagonal to the rod when seen from a plan view.

4. The rod structure of claim 2, wherein the rod contains slots.

5. The rod structure of claim 2, wherein the rod contains bulges.

6. The rod structure of claim 1, wherein the rod structure comprises a vertical piece having an upper end and a slanted piece having a first end higher than a second end wherein the second end meets with the upper end of the vertical piece.

7. The rod structure of claim 6, wherein the slots or bulges are positioned so that clothes hangers positioned in the slots or held by the bulges will be vertical when the rod is positioned in the bathtub and clothes hangers positioned in the slots or held by the bulges will be diagonal to the rod when seen from a plan view.

8. The rod structure of claim 6, wherein the rod contains slots.

9. The rod structure of claim 6, wherein the rod contains bulges.

10. The rod structure of claim 1, wherein the slots or bulges are about 6 inches apart.

11. A combination of a bathtub and the rod structure of claim 1.

12. The combination of claim 11, wherein the rod structure comprises a single slanted rod which fits in the bathtub with the first end of the rod higher than a second end of the rod.

13. The combination of claim 12, wherein the rods or bulges are positioned so that clothes hangers positioned in the slots or held by the bulges will be vertical when the rod is positioned in the bathtub and clothes hangers positioned in the slots or held by the bulges will be diagonal to the rod when seen from a plan view.

14. The combination of claim 12, wherein the rod contains slots.

15. The combination of claim 12, wherein the rod contains bulges.

16. The combination of claim 11, wherein the rod structure comprises a vertical piece having an upper end and a slanted piece having a first end higher than a second end wherein the second end meets with the upper end of the vertical piece.

17. The combination of claim 16, wherein the rods or bulges are positioned so that clothes hangers positioned in the slots or held by the bulges will be vertical when the rod is positioned in the bathtub and clothes hangers positioned in the slots or held by the bulges will be diagonal to the rod when seen from a plan view.

18. The combination of claim 17, wherein the rod contains slots.

19. The combination of claim 17, wherein the rod contains bulges.

20. The combination of claim 11, wherein the slots or bulges are about 6 inches apart.
